(19) United States
(12) Patent Application Publication
(10) Pub. No.: US 2011/0137688 A1
(43) Pub. Date: Jun. 9, 2011

(54) SYSTEM AND METHOD OF HEALTHCARE ADMINISTRATION FOR A GERIATRIC POPULATION

(76) Inventor: RICHARD MERKIN, Northridge, CA (US)

(21) Appl. No.: 13/028,535

(22) Filed: Feb. 16, 2011

Related U.S. Application Data
(63) Continuation of application No. 12/618,601, filed on Nov. 13, 2009, now abandoned.
Application No. 12/618,601 is a continuation of application No. 11/521,724, filed on Sep. 15, 2006, now abandoned.

(51) Int. Cl. G06Q 40/00; G06Q 90/00

(52) U.S. Cl. 705/4; 705/500

(57) ABSTRACT

A method of establishing a referral network for the enrollment of individuals in a geriatric healthcare insurance plan comprising identifying an age-eligible population; developing and implementing recruiting strategies to establish a relationship with the age-eligible population; and generating potential members from the age-eligible population for enrollment in a geriatric healthcare insurance plan as senior class members; and engaging senior class members to become ambassadors that represent the geriatric healthcare insurance plan to other potential members. Retention strategies such as a points program and a referral resource network are provided to retain senior class members. The referral resource network is a network of senior class members that are available to offer services to other senior class members, including valuable special skills or knowledge or necessary services. The referral resource network may be accessible to senior class members through a global electronic network, such as the Internet.

### CROSS-REFERENCE TO RELATED APPLICATIONS

The present application is a continuation of U.S. patent application Ser. No. 12/618,601, filed Nov. 13, 2009, entitled SYSTEM AND METHOD OF HEALTHCARE ADMINISTRATION FOR A GERIATRIC POPULATION which is a continuation of U.S. patent application Ser. No. 11/521,724, filed Sep. 15, 2006, entitled SYSTEM AND METHOD OF HEALTHCARE ADMINISTRATION FOR A GERIATRIC POPULATION, all of the teachings of which are incorporated herein by reference.

### STATEMENT RE: FEDERALLY SPONSORED RESEARCH/DEVELOPMENT

Not Applicable

### BACKGROUND

The present invention relates to a system and method of healthcare administration for a geriatric population. More specifically, the present invention relates to a system and method of establishing a referral network for the enrollment of individuals in a geriatric healthcare insurance plan and post-enrollment services that may be provided to each enrolled individual.

The fastest growing segment of society is the geriatric segment of the population, which generally refers to mature individuals over the age of sixty-five. According to the United States Census Bureau, 35 million people over sixty-five years of age were counted in the United States Census for the year 2000. The sixty-five to seventy-four year old age group, which represented almost seven percent of the population, consisted of approximately 18 million people. The seventy-five to eighty-four year old age group represented almost five percent of the population. Finally, the eighty-five year old and over age group represented almost two percent of the population. These numbers are expected to grow in the next few years as the members of the baby boom generation begin to reach the age of sixty-five. The baby boom generation is comprised of individuals born between the years 1946 and 1964.

Consequently, as the size of the geriatric segment of the population increases, the need for adequate resources to assist this population segment in sustaining an acceptable quality of life is greater than ever. The daily and long-term health, financial and general well-being requirements of each individual differ widely, and these needs are usually intertwined. Specifically with regard to health, the overall cost of healthcare is rising at an unsustainable rate due to an older population growing in numbers and longevity. For example, there are many chronic health conditions that are common in older people such as heart disease, arthritis, diabetes, high blood pressure and various forms of respiratory disease. The Census Bureau for the year 2000 also reported that eighty percent of older Americans were diagnosed with at least one chronic health condition and fifty percent had been diagnosed with at least two chronic health conditions. These health conditions are often genetic or age-related and may inevitably develop even if the individual maintains a health lifestyle. Generally, mature individuals may treat with one or more specialists, in addition to a regular primary care provider, to properly manage and control these conditions. Additional visits to other providers tend to increase the cost of healthcare for the mature individual who is typically on a limited budget. Thus, the increased longevity and related susceptibility to disease conditions means that healthcare-related needs and services must be addressed.

In the United States, publicly-funded healthcare insurance programs, such as Medicare, are the primary source of healthcare insurance for the mature population. The Medicare program is administered by the United States government and is specifically funded, in part, through a dedicated hospital insurance tax. Other portions originate from either general government revenues or the covered members at the time of service. Medicare is automatically offered to individuals that are sixty-five years of age or older if the individual, or their spouse, contributed to the program through payroll tax deductions during their working years. In 2005, Medicare provided healthcare coverage for 42.5 million Americans, and coverage is expected to reach 77 million when the baby boom generation is fully enrolled.

Publicly-funded health insurance, including Medicare, is generally broken into two components. The first component is hospital insurance, which covers hospital stays and admissions at other facilities if certain criteria are met. Most covered individuals do not pay a premium for this component. The second component is medical insurance, which covers most physician services, outpatient care and various other types of medical services that are not covered under the first component. Other medical services that may be covered include durable medical equipment such as canes, walkers, wheelchairs and mobility scooters.

Neither the first nor the second component covers the total amount of an individual's medical costs, and substantial cost sharing exists for many of the medical services provided to the individuals. Additionally, all covered individuals typically pay a monthly premium for publicly-funded healthcare insurance. In addition to monthly premiums, deductibles and co-payments are usually part of the program and must be paid by the covered individuals to satisfy the cost of the provided healthcare at the time of service. Publicly-funded healthcare insurance does not cover many necessary procedures and services, such as prescription drugs, routine physical examinations or dental services. Any extra costs incurred with respect to these services are the responsibility of the individual. As a result, the existing structure of publicly-funded healthcare insurance creates extra costs that are typically greater than the out-of-pocket costs associated with private or employer sponsored health plans. A mature individual on a limited budget often becomes unable to manage the cost of healthcare, which further creates a financial burden on the individual with respect to other non-related needs.

Recent legislation has provided the recipient of publicly funded healthcare insurance with the opportunity to shift their current benefits to private healthcare insurance plans. The legislation attempts to incorporate the cost-saving measures of managed geriatric healthcare into an HMO, a PPO, a Medical Savings Account or other similar private healthcare plans. Through proper administration, private healthcare insurance plans may provide the mature individual with a way to avoid the substantial out-of-pocket costs that are traditionally associated with publicly funded healthcare. A mature individual may select a healthcare insurance plan from a number of private healthcare plans and the government provides a certain amount of money each month to the selected plan provider. The mature individual continues to receive Medicare coverage, but it is through the private health insurance plan, which typically has lower out-of-pocket monthly premiums, deductibles and co-payments. The individual is free to choose a plan from any of the available healthcare providers that he or she believes provides the most comprehensive benefits. The individual may select an alternative healthcare provider at any time.

The quality of life of the mature segment of the population goes beyond the requirement of affordable healthcare services. In addition, as an individual matures, the individual may have changing lifestyle needs because of an increasing inability to independently perform normal activities due to any number of limiting reasons which can be health or financially related. The mature population does not want to be a burden on anyone, including family or society. The mature individual wants to maintain control of not only their health care, but their life. Some communities often have programs available to provide assistance to the mature segment of the population, but the programs may not be easily accessible or the individual may not know how to access them.

What is lacking is a system and method for administering healthcare services to the geriatric population that provides such services, in addition to other life-enhancing benefits. The system and method should address the need for adequate resources required by the mature individual so that the individual can maintain a standard quality of life. The system and method should also provide the mature individual with a sense of both loyalty to the healthcare plan organization and unity with the other covered members as a result of the availability of resources.

### BRIEF SUMMARY

The present invention addresses the foregoing deficiency in the art. Specifically, there is provided a method of establishing a referral network for the enrollment of individuals in a geriatric healthcare insurance plan which comprises identifying an age-eligible population; developing and implementing recruiting strategies to establish a relationship with the age-eligible population; generating potential members from the age-eligible population for enrollment as senior class members in a geriatric healthcare insurance plan provided by an organization; and engaging senior class members to become ambassadors that represent the geriatric healthcare insurance plan and the organization to other potential members.

The geriatric healthcare insurance plan may include an age-eligible population and an administration group. The age-eligible population consists of individuals of the mature segment of the population who are at least sixty-four years of age and who are within six months of the date of their sixty-fifth birthday. The age-eligible population further comprises two groups that include potential members and senior class members. Potential members are the individuals of the age-eligible population that are not enrolled in a geriatric healthcare insurance plan provided by the organization. Senior class members are the members of the age-eligible population who are currently covered by a geriatric healthcare insurance plan offered by organization. The administration group may include any number of interrelated individuals or groups of individuals that are responsible for at least one administrative function. Administration group may include a spokesperson that may be a respected member of the age-eligible group. The spokesperson represents the geriatric healthcare insurance plan.

The administration group may also include an ambassador which acts as a goodwill representative for the geriatric healthcare insurance plan. An ambassador is a senior class member that refers potential members for enrollment in the geriatric healthcare insurance plan. An ambassador engages in recruitment activities and may be awarded a bonus based on the number of successful recruits.

Retention strategies are provided to senior class members to prevent migration to other competitive organizations providing a similar geriatric healthcare insurance plan. The retention strategies may include a newsletter, an outreach program, value-added items and services, a points program or a resource referral network. The referral resource network is a network of senior class members that are available to offer services to other senior class members, including valuable special skills or knowledge or necessary services. The referral resource network may be accessible to senior class members through a global electronic network, such as the Internet.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is a flow chart depicting the steps of implementing a system and method of administering a geriatric healthcare insurance plan and services related to enrollment and post-enrollment.

FIG. 2 is a representation of an organizational structure of a geriatric healthcare insurance plan according to the present invention.

FIG. 3 represents a list of recruiting strategies that can be implemented by the administrative group of a geriatric healthcare insurance plan to recruit potential members for enrollment in the healthcare insurance plan.

FIG. 4 represents a list of retention strategies that can be implemented by the administrative group of a geriatric healthcare insurance plan to prevent migration of senior class members to competitive organizations.

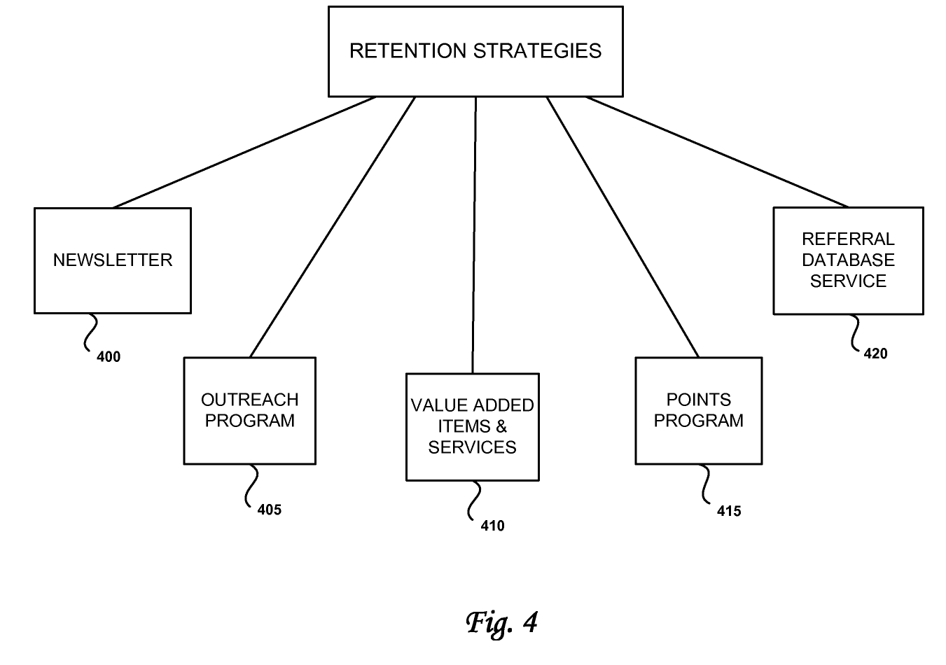

FIG. 5 is a diagrammatic representation of a resource referral network according to one aspect of the present invention.

### DETAILED DESCRIPTION

The detailed description set forth below is intended as a description of the presently preferred embodiment of the invention, and is not intended to represent the only form in which the present invention may be constructed or utilized. The description sets forth the functions and sequences of steps for constructing and operating the invention. It is to be understood, however, that the same or equivalent functions and sequences may be accomplished by different embodiments and that they are intended to be encompassed within the scope of the invention.

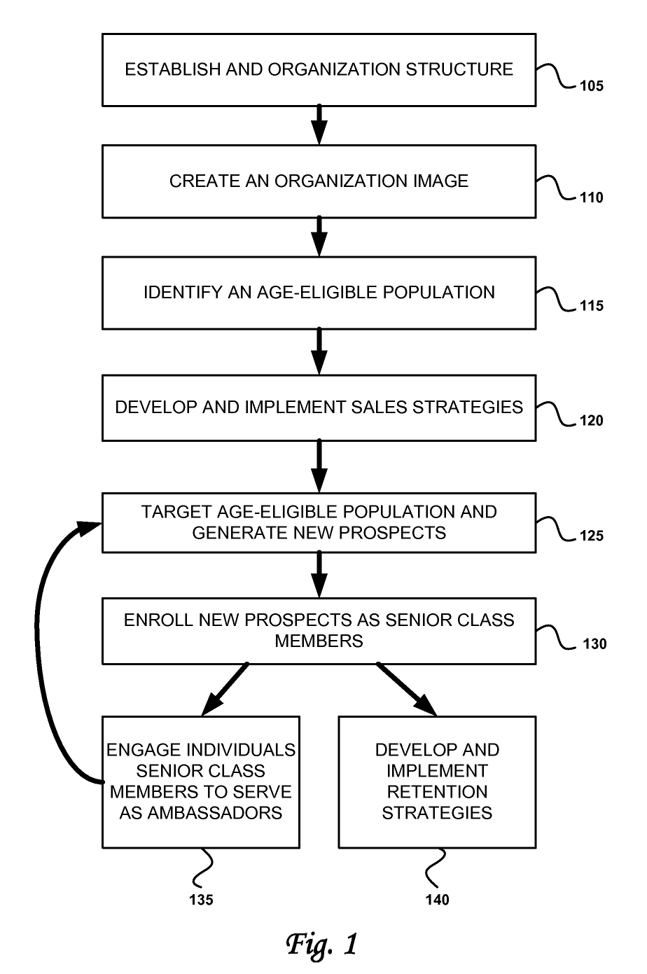

FIG. 1 represents a flow chart depicting the steps of implementing a system and method of administering a geriatric healthcare insurance plan and services related to enrollment and post-enrollment. Administration of the healthcare insurance plan is structured to address quality of life issues, in addition to healthcare, which affect the mature segment of the population.

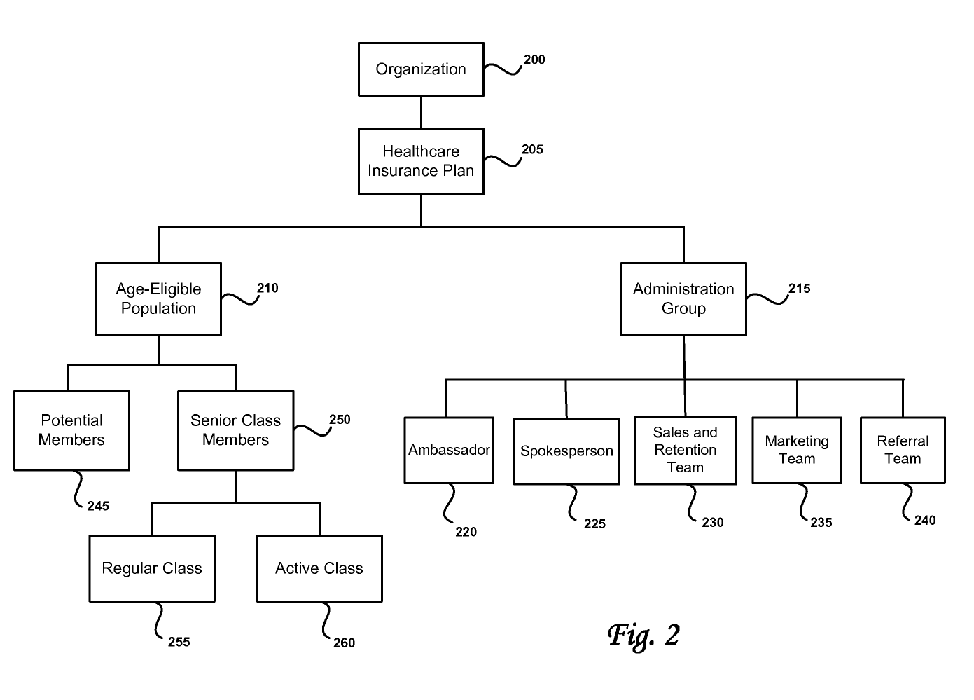

An organizational structure is established at step 105. Referring to FIG. 2, an organization 200 is generally a private healthcare insurance provider that provides at least one geriatric healthcare insurance plan 205 to individuals in the mature segment of the population. The organizational structure comprises individuals or groups of individuals that serve either an enrollment or post-enrollment purpose within the organization. The mature segment of the population is comprised of those individuals that are considered eligible for publicly-funded healthcare insurance based on their present age. Healthcare insurance plan 205 is typically a geriatric healthcare insurance plan that is designed to be administered in conjunction with a publicly-funded health insurance plan, which is primarily directed to service the mature segment of the population.

Organization 200 is stratified into at least two groups that include an age eligible population 210 and an administration group 215. The age eligible population 210 includes the individuals of the mature segment of the population who are at least sixty-four years of age and who are within six months of the date of their sixty-fifth birthday. These individuals may be identified utilizing any method available to identify and target this particular segment of the population for enrollment in a geriatric healthcare insurance plan. For example, individual data may be purchased from a company that specializes in collecting and selling such age-related information to other companies. The age-eligible population 210 may also be identified from eligibility lists provided to the organization 200 by the government.

The age-eligible population 210 is broken into two groups that include potential members 245 and senior class members 250. Potential members 245 are the individuals of the age-eligible population 210 that are not enrolled in a geriatric healthcare insurance plan 205 provided by organization 200. The activities of organization 200 with respect to the recruitment and enrollment of potential members 245 are further described herein. Senior class members 250 are the members of the age-eligible population 210 who are currently covered by a geriatric healthcare insurance plan 205 offered by organization 200. Senior class members 250 may be further classified into two groups which include regular class members 255 and active class members 260. The classification of each senior class member 250 as a regular class member 255 or an active class member 260 depends on the level of participation in the planned events that are provided by organization 200, as further described herein.

Administration group 215 consists of any number of interrelated individuals or groups of individuals that are responsible for at least one administrative function of organization 200. Administration group 215 is not limited to the organizational structure shown in FIG. 2 and may include any other individuals or groups that are necessary to provide an effective administration. For example, administration group 215 may include at least one spokesperson 225. Spokesperson 225 can be a high profile individual that is generally known to the mature population. Spokesperson 225 should be a retiree or at least in the age group of the age-eligible population 210. Spokesperson 225 may be an individual that enjoys some type of frame such as a celebrity status, or spokesperson 225 may also be a local, state or national political figure. Spokesperson 225 should be an individual that is respected by the members of the age-eligible population 210. Administration group 215 may have a single spokesperson 225 or administration group 215 may include any number of spokespersons 225 that may be appropriate to represent organization 200 and geriatric healthcare insurance plan 205. For example, the age-eligible population 210 may be dissected into several distinct geographic regions for ease of administration of the geriatric healthcare insurance plan 205. Accordingly, one or more spokespersons 225 may be appointed for each identified distinct geographic region. In another example, the frame or known identity of a particular spokesperson 225 may be limited to a particular geographic region. Thus, each spokesperson 225 may only be appropriate for the particular geographic region in which he or she enjoys such frame, and not on a national basis.

Administration group 215 should also include a sales and retention team 230, which includes at least one or more individuals to implement recruiting strategies directed to potential members 245 and retention strategies for senior class members 250. The individuals that comprise the sales and retention team 230 do not need a healthcare background. However, each member of the sales and retention team 230 should be energetic and creative. An individual sales and retention team member 230 may be a motivational speaker or a life coach. Administration group 215 may include a marketing team 235. The marketing team 235 can develop ongoing recruiting strategies to establish relationships with the potential members 245 of the age-eligible population 210 and retention strategies to maintain the relationships with the senior class members 250 covered under a geriatric healthcare insurance plan 205 provided by organization 200. Marketing team 235 may also include an event planner that can assist in planning appropriate sales, recruiting, or enrolled member retention events, such as meetings, dinners and other informational or entertainment presentations. The purpose of any such event is to provide a forum to recruit potential members 245 and retain senior class members 250 presently covered under a geriatric healthcare insurance plan 205 of organization 200. Marketing team 235 may plan events on a national basis, or, alternatively, each geographic region may have a marketing team 235 to plan the recruiting events accordingly for the particular region.

Administration group 215 may further include a referral team 240, as described in further detail herein. Generally, referral team 240 develops a resource referral network by establishing relationships with outside vendors and senior class members 250 who may be able to provide a valuable or necessary service to other senior class members 250. Referral team 240 may maintain an electronic database for this data 00or the data may be maintained in any other format that is easily accessible for dissemination to the senior class members 250 upon request.

Administration group 215 may also include at least one ambassador 220. An ambassador 220 is a senior class member 250 of organization 200 who acts as a goodwill representative for organization 200. Accordingly, ambassador 220 is a mature individual that refers potential members 245 to organization 200 for possible enrollment in a geriatric healthcare insurance plan 205 provided by organization 200. Each ambassador 220 is preferably selected from the group of senior class members 250 so that ambassador 220 has a peer status with respect to the other senior class members 250 and potential members 245. Ambassador 220 should be retired from full-time employment and should be able and willing to meet and speak to individuals and groups of individuals that are interested in obtaining information regarding enrollment in a geriatric healthcare insurance plan 205 provided by organization. Ambassador 220 may conduct outreach telephone calls to potential members 245 to invite them to planned events. Ambassador 220 may also attend and participate in planned events by serving refreshments or assisting at a registration desk. Ambassador 220 may further assist potential members 245 with completion of any enrollment forms if a potential member 245 chooses to enroll in a geriatric healthcare insurance plan 205 provided by organization 200.

Ambassador 220 may be employed at an hourly wage to work on a part-time basis for approximately twenty hours per month. Ambassador 220 may be considered a casual employee and would not be offered the benefits received by regular employees, including, but not limited to, health insurance, dental insurance or participation in a company savings plan. An ambassador 220 that is more effective in recruiting potential members 245 may be provided with more working hours than an ambassador that is less effective. Ambassador 220 may be reimbursed for any actual and reasonable transportation costs incurred in traveling to and from any planned events that are offered by organization 200.

Each ambassador 220 may further receive a bonus for each potential member 245 that becomes a senior class member 250 as a result of a successful recruitment effort of ambassador 220. For example, an ambassador 220 may be active in one or more community activities. Ambassador 220 may meet individuals at any such community activity and invite them to a planned event of organization 200 as a potential member 245. If the individual enrolls as a senior class member 250, the ambassador 220 can be awarded a bonus based on this enrollment. The bonus may be a one time bonus per enrollee that is paid subsequent to the final approval of potential member 245 by both the organization 200 and any interested government agency. Alternatively, the bonus may be awarded based on a monthly volume of applications initiated by ambassador 220 that proceed to enrollment. Other activities of an ambassador 220 may also be considered a recruitment effort which may result in an approved enrollment, such as sending an invitation to a particular potential member 245, hosting an event or greeting and speaking with a potential member 245 regarding certain aspects of being a senior class member 250. It should be noted that an ambassador 220 may require a license to discuss healthcare plan benefits with potential members 245. Thus, an ambassador 220 may be limited to recruitment of potential members 245 or other senior class members 250 to become an ambassador 220. An ambassador 220 may discuss the non-healthcare plan related benefits, such as upcoming planned events of the organization 200.

Referring to FIGS. 1 and 2, at step 110, an organization image is created. The organization 200 is inherently customer-focused due to the nature of the services provided by the organization 200. A potential member 245 engages the organization 200 because of a defined and recognized need for the services provided by the organization 200, or the organization 200 may purport to provide a specific benefit to the potential member 245. Thus, the organization 200 must first determine the needs of its potential members 245 and subsequently develop a corresponding organization identity. The organization 200 is directing its service primarily to the mature individuals that define a particular segment of the general population that is increasing in numbers, specifically the mature population. The organization 200 may develop an identity in the form of a logo and a slogan that is appropriate for this targeted age group. The organization 200 may develop the identity internally or the organization 200 may contract with an outside entity, such as a marketing company, to develop an appropriate image and associated materials which appeal to the target audience. The initial identity of the organization 200 may be modified at any time in accordance with the changing demographic composition or the needs of the target segment of the population.

At step 115, an age-eligible population is identified. As previously described, individual data may be purchased from a company that specializes in collecting such information or the age-eligible population 210 may be identified from eligibility lists provided by the government.

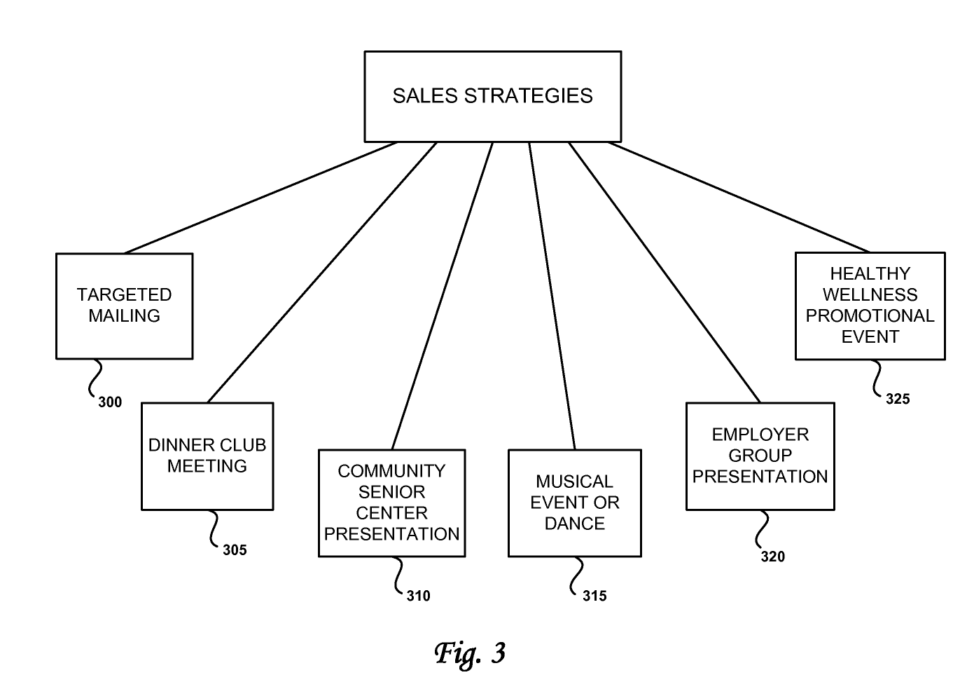

Next, sales strategies are developed and implemented at 120 that correlate with the interests and needs of the age-eligible population 210. The development of sales strategies to recruit potential members 245 for enrollment in a geriatric healthcare plan 205 provided by organization 200 is one of the two major aspects of the method described herein. The other is the expansion of the relationships established with senior class members 250. The sales strategies are typically developed by the sales and retention team 225 and may be implemented with the assistance of the marketing team 230. FIG. 3 provides an example list of the sales strategies that may be used to establish relationships with potential members 245.

A targeted mailing 300 may be used to target the age-eligible population 210. Targeted mailing 300 may consist of a mass mailing to the age-eligible population 210 containing literature regarding the services that the organization 200 can offer with regard to its geriatric healthcare insurance plan 205. Targeted mailing 300 may also be a more individualized mailing. For example, based on the information obtained with regard to the age-eligible population 210, a birthday card mailing may be sent to an age-eligible individual. The birthday card may have a picture of a mature adult with a piece of cake having a candle thereon. The birthday card can have an appropriate message to the individual such as “Now you can have your cake and eat it too.” The card may be designed to have the ability to play music, such as the song Happy Birthday. The inner portion of the card may also contain general information regarding the geriatric healthcare insurance plan 205 in addition to a brief overview of the services provided by the organization 200 and the existence of the nonhealthcare related activities of the senior class members 250. Information regarding the geriatric healthcare insurance plan 205 and organization 200 may be also printed on a separate brochure and provided in addition to the birthday card.

Another example of a sales strategy is a dinner club meeting 305. A dinner club meeting 305 may be a one time event in which a restaurant is selected and the event is advertised in an appropriate manner so that the age-eligible population 210 is aware of its occurrence. The dinner club meeting 305 may be used as an open forum to discuss issues that affect the mature segment of the population. A speaker may be recruited for a directed discussion on any similarly relevant issue. The dinner club meeting 305 may be a one-time event or the dinner club meeting may occur on a regular basis.

Similarly, community senior center presentations 310 provide another opportunity for the organization 200 to promote the services to the age-eligible population 210. Community senior center presentations 310 are similar to a dinner club meeting 305 in that an opportunity is provided for an open forum or a directed discussion regarding issues that affect the mature segment of the population.

Music events or dances 315 may also be used as a sales strategy to recruit potential members 245 of the age-eligible population 210. Music events or dances 315 may include any type of music, such as jazz, big band, or symphony music. The organization 200 may have a table or booth at the music event or dance 315 and can provide literature regarding the geriatric healthcare insurance plan 205 or other literature that provides information relevant to issues that affect the mature segment of the population.

Employer group presentations 320 may be presented to employer groups with a special emphasis on retiring or retired individuals. The geriatric health insurance plan 205 may be presented as an option to the retiring or retired individual in addition to other available options, such as the individual's desire to continue paying for commercial plan benefits. This approach can be used to represent the advantages to the employer with respect to a changed age and gender demographic of the company and to the retiree regarding the premium payment savings of the mature individual with access to improved benefits.

A health and wellness promotional event 325 is another sales and recruiting event to increase health awareness through health screenings, activities, materials and demonstrations. Health and wellness promotional events 325 provide an opportunity to increase awareness of local, state and national health services and resources. The organization 200 may have a booth or table at the event which may be staffed with at least one ambassador 220, members of the sales and retention team 230 or at least one spokesperson 225. Literature may be provided to interested potential members 245 if they approach the booth or table and express an interest in the information. Sales presentations may or may not be made at the event. Each event may be a sole-sponsor event which means that the organization 200 is the single-sponsor of an event. The event may be a multiple sponsor event indicating that the organization 200 has collaborated sponsorship with another sponsor for the event. If the organization 200 chooses to co-sponsor an event with other organizations, the co-sponsors may be chosen based on the type of services or products provided. For example, the organization 200 may choose to co-sponsor an event with a hospital; a physician group; a nutritional products retail store; a medical supply store, or a pharmaceutical company. Events that are sole-sponsored by the organization 200 may be subject to governmental agency regulations regarding promotional items having a certain monetary value that are provided to attendees. Events that are co-sponsored by the organization 200 in association with another sponsoring organization may or may not be subject to similar regulations.

Each of the above sales strategies are utilized to target the age-eligible population 210 to generate potential members 245 at step 125. Next, the organization 200 should enroll at least one individual in a geriatric healthcare insurance plan 205, at which time the individual also becomes a senior class member 250 at step 130. An individual who is enrolled as a senior class member 250 may be further engaged to serve as an ambassador 220 at step 135. If a geriatric healthcare insurance plan 205 already exists and has any number of enrolled members, the health care insurance plan may cause each member to become a senior class member 250, as described herein, and choose to engage any of the senior class members 250 to become an ambassador 220 before identifying any additional individuals of the age-eligible population 210.

The process shifts to building the relationship by providing and further enhancing the benefits that interested the potential member 245 to become an senior club member 250. The organization 200 should have a member-driven focus which means that the organization 200 focuses its activities and products on the senior class member 250 needs. Thus, the sales and retention team 230 in association with the marketing team 235 must continuously improve the service provided by the organization 200 in order to retain its senior class members 250 and prevent migration to other competitive organizations providing a similar geriatric healthcare insurance plan 205.

Accordingly, retention strategies are developed and implemented at step 140. The organization 200 should provide a sense of belonging to each senior class member 250 which creates a sense of loyalty to the organization 200. An example of a retention strategy is a newsletter 400 that may be provided to each senior class member 250. The newsletter 400 is a periodic publication that is sent to senior class members 250 at defined intervals. Each newsletter 400 may be focused on a different subject, which may include any number of topics that encompass issues that affect the mature segment of the population. The newsletter 400 may also have announcements, such as the addition of a new physician or the retirement of an existing physician, and event listings of the planned events provided by the organization 200. The newsletter 400 may be in print and it may also be transmitted by electronic mail, if the senior class member 250 can receive information electronically. The newsletter 400 may be part of a targeted mailing to potential members 245, as previously described.

Another retention strategy is a redirect program 405 which is an outreach to senior class members 250 triggered by the occurrence of an event. Specifically, when a primary care provider has announced an upcoming retirement, affected senior class members 250 may opt to find a new healthcare insurance plan. The organization 200 contacts each affected senior class member 250 to assist them in selecting a new primary care provider before the senior class member 250 decides to leave the geriatric healthcare insurance plan 205 provided by organization 200. Another similar redirect program 405 retention strategy is a birthday celebration program. Each senior class member 250 receives a birthday card each year from organization 200 during the month of their birthday in a manner similar to the dissemination of the targeted mailing previously described with respect to potential members 245.

Another retention strategy that may be incorporated by the organization 200 is a value-added items and services program 410 which includes items and services that do not meet the definition of benefits and are provided to senior class members 250 of the organization 200. A benefit has a regulatory definition of a healthcare item or service submitted and approved through a bid process, such item or service being intended to maintain or improve the health status of senior class members 250 and for which an organization 200 must incur a cost or liability related to the item or service. If an item or service fails to meet this definition, the item or service is not a benefit and may be offered to senior class members 250 as part of the value-added item and services program 410. Referral team 240 may coordinate the value-added items and service program 410 by establishing relationships with outside vendors or corporations to provide an item or service to senior class members 250 at a predetermined discount.

Each senior class member 250 is provided with a card for presentation to a value-added item or service provider for the purpose of obtaining access to the item or service. Value-added services and items may be health related or non-health related. Examples of health related value-added services or items include discounts on items such as dental services; vision products or services, including eyeglass frames, contact lenses or vision correction surgeries; discounts on health club memberships; alternative care programs including acupuncture, massage, nutritional counseling and chiropractic services, as well as vitamins, nutritional supplements, aromatherapy, and more; or hearing aid products and services such as comprehensive hearing tests, hearing aids and free hearing aid services. Non-health related value-added services or items include discounts in restaurants, stores, entertainment, travel or financial services.

Each value-added item or service may be offered to each senior class member 250. The value-added item or service should not be described as a covered benefit and the organization 200 should not imply that the value-added service or item is recommended by the organization 200 or the administration of the publicly-funded healthcare insurance program. If any protected health information is to be used or disclosed for the purpose of marketing and providing the value-added services or items, the organization 200 must comply with all applicable HIPAA laws, such as obtaining an authorization from each senior class member 250 before using or disclosing their personal information.

Another retention strategy may be a points program 415, which is a method of awarding points to senior class members 250 based on their participation as an active senior club member 260. Senior class members 250 are active members 260 if such members participate in planned events of the organization or serve as an ambassador 220. Senior class members 250 that do not participate in planned events are considered regular members 255. Participation in planned events by senior class members 250 and classification as an active member 260 or a regular member 255 does not affect the healthcare plan status of senior class member 250 or the benefits provided there under. Classification as an active member 260 or regular member 255 only refers to the extra benefits that may be provided to senior class members 250 as a result of participation in the planned events.

Senior class members 250 who are also active members 260 may earn points if they assist with planned events, bring a guest to planned events or attend meetings provided by organization 200. Each awarded point may correspond to a certain value. For example, organization 200 may coordinate local or overnight trips such as a bus trip to a casino or a shopping trip. These trips may be offered for a fee to both potential members 245 and senior class members 250. A senior class member 250 may redeem a certain amount of earned points to offset a portion of the cost of such a trip. Point values may be awarded in any manner determined by the organization 200. Ambassadors 220 may earn double points for heightened participation above that of a senior class member 250.

Yet another retention strategy that may be provided to senior class members 250 is a resource referral network 420, which defines a network of senior class members 250 that are available to offer services to other senior class members 250 of the organization 200. Each senior class member 250 generally has a lifetime of experience, training and skill in certain areas. Depending on the type of skill, the senior class member 250 may be able to assist other senior class members 250 who have a need for the type of service that can be provided. Senior class members 250 may include retired attorneys who may be able to provide legal insight into certain aspects of the law that typically affect the mature segment of the population, including trusts, wills and property. Senior class members 250 may also include artists, photographers or musicians; skilled trade individuals such as car mechanics, plumbers or carpenters; or individuals who can provide transportation or other daily life requirements to those in need. The referral team 240 may work with ambassadors 220 and other senior class members 250 to generate and maintain the resource referral network 420 of senior class members 250 capable of providing a service that may be valuable to another senior class member 250.

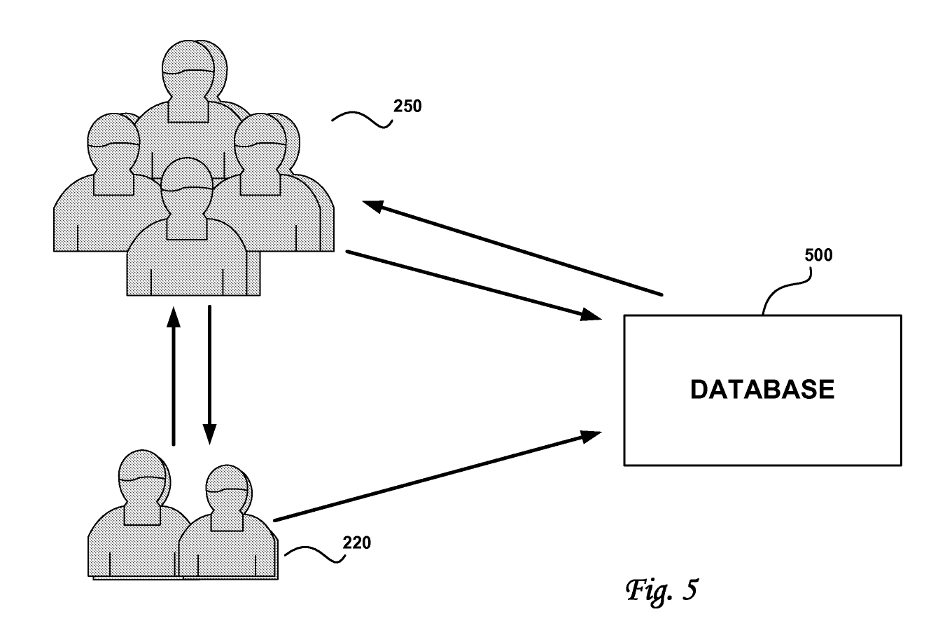

A diagrammatic representation of a resource referral network 420 is shown in FIG. 5. Ambassador 220 is in communication with as many senior class members 250 as possible to obtain information regarding any skills, services or special knowledge that a senior class member 250 may be able to provide to other senior class members 250. Ambassador 220 may obtain this information in any manner, such as by telephone communication with a senior class member 250. Ambassador 220 may also contact senior class members 250 by email or by postal mail. Similarly, ambassador 220 may provide each senior class member 250 with a questionnaire having a specific request to describe unique skills. The questionnaire may also include a list of categories regarding possible daily needs of senior class members 250. The questionnaire could request each senior class member 250 to provide information regarding services that the member may be able to provide with regard to each category. The ambassador 220 collects the information and provides the same to the referral team 240 which maintains a referral database 500 of the information. Referral team 240 may maintain an electronic referral database 500 for this data or the data may be maintained in any other non-electronic format so long as the information is easily accessible for dissemination to the senior class members 250 upon request. If this information is maintained in an electronic referral database 500, the referral team 240 may provide a web site to senior class members 250 so that the information contained within the electronic referral database 500 is accessible to members through the web site via a global electronic network, such as the Internet.

For example, a senior class member 250 may indicate that they play a musical instrument in a band that provides musical services at weddings. The senior class member 250 provides this information to ambassador 220 who then forwards the information to referral team 240 for incorporation into the referral database 500. Another senior class member 250 may have a need for a band to play at a granddaughter's wedding reception. The senior class member 250 in need of the band submits a request to the referral team 240 for a list of senior class members 250 that can provide this type of service. Another example may be a senior class member 250 that wants to provide transportation services to other senior class members 250. The member provides geographic information regarding where they live and particular establishments they may visit on a regular basis, such as a certain grocery store or church. Specifically, the senior class member 250 may visit a certain grocery store once a week on the same day. The senior class member 250 may wish to provide carpool transportation services to other senior class members 250 to the same grocery store, if needed. Such contact between senior class members 250 may be made through the referral database 500. The senior class member 250 in need would contact the referral team 240 of organization 200 and request a search of the referral database for senior class members 250 within the geographic area that have indicated a desire to provide such transportation services to other senior class members 250.

It should be recognized that additional modifications and improvements of the present invention may also be apparent to those of ordinary skill in the art. Thus, the particular combination of parts and steps described and illustrated herein is intended to represent only certain embodiments of the present invention, and is not intended to serve as limitations of alternative devices and methods within the spirit and scope of the invention.

Through the mechanisms disclosed herein, the systems and methods of the present invention will be operative to establish a referral network for the enrollment of individuals in a geriatric healthcare insurance plan and post-enrollment services related thereto that may be provided to each enrolled individual. It is contemplated that the systems and methods, although ideally suited for use within geriatric healthcare insurance plans, the same may find widespread applicability in virtually every type of organization responsible for the administration of healthcare services and certain post-enrollment services. Accordingly, all far reaching applications should be considered to fall within the scope of the present invention.

What is claimed is:

1. A method of establishing a referral network for the enrollment of individuals in a geriatric healthcare insurance plan, the method comprising:
identifying an age-eligible population;
developing and implementing sales strategies to establish a relationship with the age-eligible population;
targeting the age-eligible population with the sales strategies to generate potential members for the geriatric healthcare insurance plan;
enrolling the potential members in the geriatric healthcare insurance plan as senior class members;
engaging at least one senior class member to serve as an ambassador, wherein the ambassador assists in generating potential members for the geriatric healthcare insurance plan; and
developing and implementing retention strategies to retain senior class members.

2. The method of claim 1, wherein the age-eligible population comprises individuals of a mature segment of the population.

3. The method of claim 1, wherein an administration group develops and implements sales and retention strategies.

4. The method of claim 3, wherein the sales strategies comprise at least one of a targeted mailing, a dinner club meeting, a musical event or dance, a community senior presentation, an employer group presentation or a health and wellness promotional event.

5. The method of claim 3, wherein the administration group comprises at least one spokesperson to represent the geriatric healthcare insurance plan, the spokesperson being a member of the age-eligible population.

6. The method of claim 3, wherein the administration group maintains a resource referral network of senior class members that provide a service to other senior class members.

7. The method of claim 6, wherein at least one ambassador is in communication with senior class members to obtain referral data regarding a service that can be provided to other senior class members.

8. The method of claim 7, wherein the service is a special skill or a general need.

9. The method of claim 6, wherein the resource referral network comprises an electronic referral database.

10. The method of claim 9, wherein the electronic referral database can be used to provide referral data through a global electronic network.

11. The method of claim 10, wherein the referral data is the name of a senior class member that can provide a service that is at least one of special skill or a general need.

12. The method of claim 1, wherein the retention strategies comprise at least one of a newsletter, an outreach program, a value added item or service, a points program or a resource referral network.

13. The method of claim 12, wherein the resource referral network comprises an electronic referral database.

14. The method of claim 13, wherein the electronic referral database can be used to provide referral data through a global electronic network.
